(19) United States
(12) Patent Application Publication
(10) Pub. No.: US 2021/0280190 A1
(43) Pub. Date: Sep. 9, 2021

(54) HUMAN-MACHINE INTERACTION

(71) Applicant: BEIJING BAIDU NETCOM SCIENCE AND TECHNOLOGY CO., LTD., BEIJING (CN)

(72) Inventors: Wenquan Wu, Beijing (CN); Hua Wu, Beijing (CN); Haifeng Wang, Beijing (CN)

(73) Assignee: BEIJING BAIDU NETCOM SCIENCE AND TECHNOLOGY CO., LTD., BEIJING (CN)

(21) Appl. No.: 17/327,706

(22) Filed: May 22, 2021

(30) Foreign Application Priority Data
Dec. 30, 2020 (CN) 202011598915.9

(51) Int. Cl. G10L 15/22; G10L 15/06; G06F 40/35; G06T 13/00; G06K 9/00; G10L 25/57; G10L 15/25; G10L 15/18

(52) U.S. Cl. CPC G10L 15/22; G10L 15/063; G06F 40/35; G10L 15/1815; G06K 9/00744; G10L 25/57; G10L 15/25; G06T 13/00

(57) ABSTRACT

A method and apparatus for human-machine interaction, a device, and a medium are provided. A specific implementation solution is: generating reply text of a reply to a received speech signal based on the speech signal; generating a reply speech signal corresponding to the reply text based on a mapping relationship between a speech signal unit and a text unit, the reply text including a group of text units; determining an identifier of an expression and/or action based on the reply text, the expression and/or action being presented by a virtual object; and generating an output video including the virtual object based on the reply speech signal and the identifier of the expression and/or action, the output video including a lip shape sequence determined based on the reply speech signal and to be presented by the virtual object.

### CROSS REFERENCE TO RELATED APPLICATION

This application claims priority to Chinese Patent Application No. 202011598915.9, filed on Dec. 30, 2020, the contents of which are hereby incorporated by reference in their entirety for all purposes.

### TECHNICAL FIELD

The present disclosure relates to the field of artificial intelligence, and particularly to a method and apparatus for human-machine interaction, a device, and a medium in the field of deep learning, speech technologies, and computer vision.

### BACKGROUND

With the rapid development of computer technologies, there are more and more interaction between humans and machines. In order to improve user experience, human-machine interaction technologies have been rapidly developed. After a user issues a speech command, a computing device recognizes the speech of the user by speech recognition technologies. After the recognition is completed, an operation corresponding to the speech command of the user is performed. Such a speech interaction manner improves the experience of human-machine interaction. However, there are still many problems that need to be solved during human-machine interaction.

### SUMMARY

The present disclosure provides a method and apparatus for human-machine interaction, a device, and a medium.

According to a first aspect of the present disclosure, a method for human-machine interaction is provided. The method comprises generating, using at least one processor, reply text of a reply to a received speech signal based on the speech signal. The method further comprises generating, using at least one processor, a reply speech signal corresponding to the reply text based on a mapping relationship between a speech signal unit and a text unit, the reply text including a group of text units, and the generated reply speech signal including a group of speech signal units corresponding to the group of text units. The method further comprises determining, using at least one processor, an identifier of an expression and/or action, i.e., an identifier of at least one of an expression and action, based on the reply text, wherein the expression and/or action is presented by a virtual object. The method further comprises generating, using at least one processor, an output video including the virtual object based on the reply speech signal and the identifier of the expression and/or action, the output video including a lip shape sequence determined based on the reply speech signal and to be presented by the virtual object.

According to a second aspect of the present disclosure, an apparatus for human-machine interaction is provided. The apparatus includes a reply text generation module configured to generate reply text of a reply to a received speech signal based on the speech signal; a first reply speech signal generation module configured to generate a reply speech signal corresponding to the reply text based on a mapping relationship between a speech signal unit and a text unit, the reply text including a group of text units, and the generated reply speech signal including a group of speech units corresponding to the group of text units; an identifier determination module configured to determine an identifier of an expression and/or action based on the reply text, wherein the expression and/or action is presented by a virtual object; and a first output video generation module configured to generate an output video including the virtual object based on the reply speech signal and the identifier of the expression and/or action, the output video including a lip shape sequence determined based on the reply speech signal and to be presented by the virtual object.

According to a third aspect of the present disclosure, an electronic device is provided. The electronic device comprises at least one processor; and a memory communicatively connected to the at least one processor, wherein the memory stores instructions configured to be executed by the at least one processor, the instructions, when executed by the at least one processor, causing the at least one processor to perform the method according to the first aspect of the present disclosure.

According to a fourth aspect of the present disclosure, a non-transitory computer-readable storage medium storing computer instructions is provided, wherein the computer instructions are used to cause a computer to perform the method according to the first aspect of the present disclosure.

It should be understood that the content described in this section is not intended to identify critical or important features of the embodiments of the present disclosure, and is not used to limit the scope of the present disclosure. Other features of the present disclosure will be easily understood through the following specification.

### BRIEF DESCRIPTION OF THE DRAWINGS

The accompanying drawings are used to better understand the solution, and do not constitute a limitation on the present disclosure.

FIG. 1 shows a schematic diagram of an environment 100 in which a plurality of embodiments of the present disclosure can be implemented.

FIG. 2 shows a flowchart of a process 200 for human-machine interaction according to some embodiments of the present disclosure.

FIG. 3 shows a flowchart of a method 300 for human-machine interaction according to some embodiments of the present disclosure.

FIG. 4 shows a flowchart of a method 400 for training a dialog model according to some embodiments of the present disclosure.

FIG. 5A and FIG. 5B show examples of a dialog model network structure and a mask table according to some embodiments of the present disclosure, respectively.

FIG. 6 shows a flowchart of a method 600 for generating a reply speech signal according to some embodiments of the present disclosure.

FIG. 7 shows a schematic diagram of an example 700 of description of an expression and/or action according to some embodiments of the present disclosure.

FIG. 8 shows a flowchart of a method 800 for acquiring and using an expression and action recognition model according to some embodiments of the present disclosure.

FIG. 9 shows a flowchart of a method 900 for generating an output video according to sonic embodiments of the present disclosure.

FIG. 10 shows a flowchart of a method 1000 for generating an output video according to some embodiments of the present disclosure.

FIG. 11 shows a schematic block diagram of an apparatus 1100 for human-machine interaction according to an embodiment of the present disclosure.

FIG. 12 shows a block diagram of a device 1200 that can implement a plurality of embodiments of the present disclosure.

### DETAILED DESCRIPTION OF EMBODIMENTS

Example embodiments of the present disclosure are described below in conjunction with the accompanying drawings, wherein various details of the embodiments of the present disclosure are included to facilitate understanding, and should only be considered as example. Therefore, those of ordinary skill in the art should recognize that various changes and modifications can be made to the embodiments described here without departing from the scope and spirit of the present disclosure. Likewise, for clarity and simplicity, description of well-known functions and structures are omitted in the following description.

In the description of the embodiments of the present disclosure, the term “comprising” and similar terms should be understood as non-exclusive inclusion, that is, “including but not limited to”, The term “based on” should be understood as “at least partially based on”. The term “an embodiment” or “the embodiment” should be understood as “at least one embodiment”. The terms “first”, “second”, etc. may refer to different or the same objects. Other explicit and implicit definitions may also be included below

An important objective of artificial intelligence is to enable machines to interact with humans like real people. Nowadays, the form of interaction between machines and humans has evolved from interface interaction to language interaction. However, in traditional solutions, only interaction with limited content or only speech output can be performed. For example, interaction content is mainly limited to command-based interaction in limited fields, for example, “checking the weather”, “playing music”, and “setting an alarm clock”. In addition, an interaction mode is relatively simple and only includes speech or text interaction. Moreover, human-machine interaction lacks personality attributes, and a machine is more like a tool rather than a conversational person.

In order to at least solve the above-mentioned problems, according to the embodiments of the present disclosure, an improved solution is proposed. In the present solution, a computing device generates reply text of a reply to a received speech signal based on the speech signal. Then, the computing device generates a reply speech signal corresponding to the reply text. The computing device determines an identifier of an expression and/or action based on the reply text, the expression and/or action being presented by a virtual object. Then, the computing device generates an output video including the virtual object based on the reply speech signal and the identifier of the expression and/or action. By means of the method, the range of interaction content can be significantly increased, the quality and level of human-machine interaction can be improved, and the user experience can be improved.

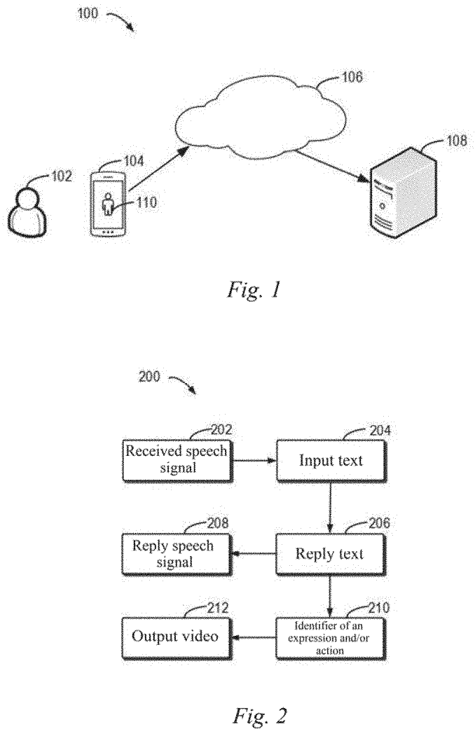

FIG. 1 shows a schematic diagram of an environment 100 in which a plurality of embodiments of the present disclosure can be implemented. The example environment can be used to implement human-machine interaction. The example environment 100 comprises a computing device 108 and a terminal device 104.

A virtual object 110, such as a virtual person, in the terminal 104 can be used to interact with a user 102. During the interaction, the user 102 can send an inquiry or chat sentence to the terminal 104. The terminal 104 can be used to acquire a speech signal of the user 102, and present, using the virtual object 110, an answer to the speech signal input of the user, so as to implement a human-machine dialog.

The terminal 104 may be implemented as any type of computing device, including but not limited to a mobile phone (for example, a smartphone), a laptop computer, a portable digital assistant (PDA), an e-book reader, a portable game console, a portable media player, a game console, a set-top box (STB), a smart television (TV), a personal computer, an on-board computer (for example, a navigation unit), a robot, etc.

The terminal 104 transmits the acquired speech signal to the computing device 108 through a network 106. The computing device 108 may generate, based on the speech signal acquired from the terminal 104, a corresponding output video and output speech signal to be presented by the virtual object 110 on the terminal 104.

FIG. 1 shows a process of acquiring, at the computing device 108, an output video and an output speech signal based on an input speech signal, and the process is merely an example and does not constitute a specific limitation on the present disclosure. The process may be implemented. on the terminal 104, or a part of the process is implemented on the computing device 108, and the other part thereof is implemented on the terminal 104. In some embodiments, the computing device 108 and the terminal 104 may be integrated. FIG. 1 shows that the computing device 108 is connected to the terminal 104 through the network 106, which is merely an example and does not constitute a specific limitation on the present disclosure. The computing device 108 may also be connected to the terminal 104 in other manners, for example, using a network cable. The above-mentioned example is only used to describe the present disclosure and does not constitute a specific limitation on the present disclosure.

The computing device 108 may be implemented as any type of computing device, including but not limited to a personal computer, a server computer, a handheld or laptop device, a mobile device (such as a mobile phone, a personal digital assistant (PDA), and a media player), a multi-processor system, a consumer electronics, a minicomputer, a mainframe computer, a distributed computing environment including any one of the above systems or devices, etc. The server may be a cloud server, which is also referred to as a cloud computing server or a cloud host and is a host product in a cloud computing service system, to solve defects of difficult management and weak business expansion in traditional physical hosts and VPS (“Virtual Private Server”, or “VPS” for short) services. The server may alternatively be a server in a distributed system, or a server combined with a blockchain.

The computing device 108 processes the speech signal acquired from the terminal 104 to generate the output speech signal and the output video for answering.

By means of the method, the range of interaction content can be significantly increased, the quality and level of human-machine interaction can be improved, and the user experience can be improved.

In the above, FIG. 1 shows the schematic diagram of the environment 100 in which a plurality of embodiments of the present disclosure can be implemented. The following describes a schematic diagram of a method 200 for human-machine interaction in conjunction with FIG. 2. The method 200 can be implemented by the computing device 108 in FIG. 1 or any appropriate computing device.

As shown in FIG. 2, the computing device 108 obtains a received speech signal 202, Then, the computing device 108 performs speech recognition (ASR) on the received speech signal to generate input text 204. The computing device 108 can use any appropriate speech recognition algorithm to obtain the input text 204.

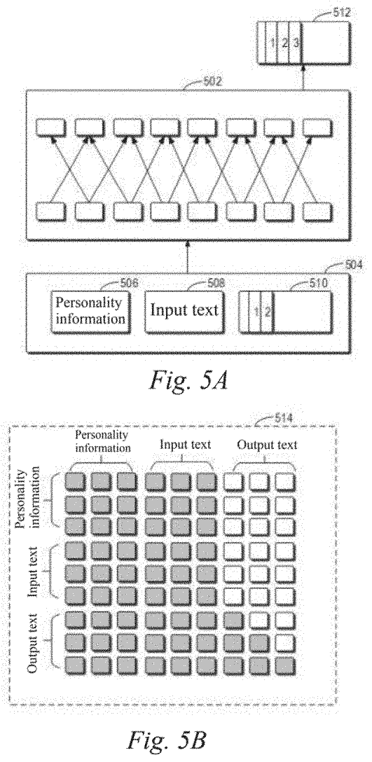

The computing device 108 inputs the obtained input text 204 to a dialog model to obtain reply text 206 for answering. The dialog model is a trained machine learning model, a training process of which can be performed offline. Alternatively or additionally, the dialog model is a neural network model, and the training process of the dialog model is described below in conjunction with FIG. 4, FIG. 5A, and FIG. 5B.

Then, the computing device 108 uses the reply text 206 to generate a reply speech signal 208 by a text-to-speech (TTS) technology, and may further recognize, according to the reply text 206, an identifier 210 of an expression and/or action used in the current reply. In some embodiments, the identifier may be a label of the expression and/or action. In some embodiments, the identifier is a type of the expression and/or action. The above-mentioned example is only used to describe the present disclosure and does not constitute a specific limitation on the present disclosure.

The computing device 108 generates an output video 212 according to the obtained identifier of the expression and/or action. Then, the reply speech signal 208 and the output video 212 are sent to a terminal to be synchronously played on the terminal.

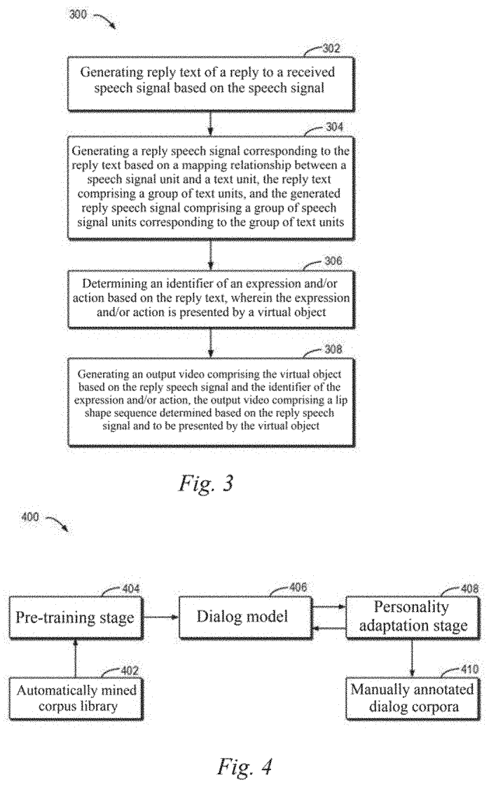

In the above, FIG. 2 shows the schematic diagram of a process 200 for human-machine interaction according to some embodiments of the present disclosure. The following describes a flowchart of a method 300 for human-machine interaction according to some embodiments of the present disclosure in conjunction with FIG. 3. The method 300 in FIG. 3 is performed by the computing device 108 in FIG. 1 or any appropriate computing device.

At block 302, reply text of a reply to a received speech signal is generated based on the speech signal. For example, as shown in FIG. 2, the computing device 108 generates the reply text 206 for the received speech signal 202 based on the received speech signal 202.

In some embodiments, the computing device 108 performs recognition on the received speech signal to generate the input text 204. The speech signal can be processed using any appropriate speech recognition technology to obtain the input text. Then, the computing device 108 acquires the reply text 206 based on the input text 204, By means of this method, reply text for speech received from a user can be quickly and efficiently obtained.

In some embodiments, the computing device 108 inputs the input text 204 and personality attributes of a virtual object to a dialog model to acquire the reply text 206, the dialog model being a machine learning model which generates the reply text using the personality attributes of the virtual object and the input text. Alternatively or additionally, the dialog model is a neural network model. In some embodiments, the dialog model may be any appropriate machine learning model. The above-mentioned example is only used to describe the present disclosure and does not constitute a specific limitation on the present disclosure. By means of the method, reply text can be quickly and accurately determined.

In some embodiments, the dialog model is obtained by performing training with personality attributes of the virtual object and dialog samples, the dialog samples including an input text sample and a reply text sample. The dialog model may be obtained by the computing device 108 through offline training. The computing device 108 first acquires the personality attributes of the virtual object, where the personality attributes describe human-related features of the virtual object, for example, gender, age, constellation, and other human-related characteristics. Then, the computing device 108 trains the dialog model based on the personality attributes and the dialog samples, wherein the dialog samples include the input text sample and the reply text sample. During training, the personality attributes and the input text sample are used as input and the reply text sample is used as output for training. In some embodiments, the dialog model may alternatively be obtained by another computing device through offline training. The above-mentioned example is only used to describe the present disclosure and does not constitute a specific limitation on the present disclosure. By means of this method, a dialog model can be quickly and efficiently obtained.

The following describes training of the dialog model in conjunction with FIG. 4, FIG. 5A, and FIG. 5B. FIG, 4 shows a flowchart of a method 400 for training a dialog model according to some embodiments of the present disclosure; FIG. 5A and FIG. 5B show examples of a dialog model network structure and the used mask table according to some embodiments of the present disclosure.

As shown in FIG. 4, in a pre-training stage 404, a dialog model 406 is trained using a corpus library 402 such as 1 billion real-person dialog corpora automatically mined on a social platform, so that the model has a basic open-domain dialog capability. Then, manually annotated dialog corpora 410 such as 50 thousand dialog corpora with specific personality attributes are obtained. In a personality adaptation stage 408, the dialog model 406 is further trained, so that it has a capability to use a specified personality attribute for a dialog. The specified personality attribute is a personality attribute of a virtual person to be used in human-machine interaction, such as gender, age, hobbies, constellation, etc. of the virtual person.

FIG. 5A shows a model structure of a dialog model, the model structure including input 504, a model 502, and a further reply 512. The model is a transformer model in a deep learning model, and the model is used to generate one word in a reply each time. Specifically, the process inputs personality information 506, input text 508, and a generated part of a reply 510 (for example, words 1 and 2) to the model to generate a next word (3) in the further reply 512, and then a complete reply sentence is generated in such a recursive manner. During the model training, a mask table 514 in FIG. 5B is used to perform a batch operation for reply generation, to improve efficiency.

Now referring back to FIG. 3, at block 304, a reply speech signal corresponding to the reply text is generated based on a mapping relationship between a speech signal unit and a text unit, the reply text including a group of text units, and the generated reply speech signal including a group of speech signal units corresponding to the group of text units. For example, the computing device 108 generates the reply speech signal 208 corresponding to the reply text 206 based on a pre-stored mapping relationship between a speech signal unit and a text unit, the reply text including a group of text units, and the generated reply speech signal including a group of speech signal units corresponding to the group of text units.

In some embodiments, the computing device 108 divides the reply text 206 into a group of text units. Then, the computing device 108 acquires a speech signal unit corresponding to a text unit of the group of text units based on the mapping relationship between a speech signal unit and a text unit. The computing device 108 generates the reply speech signal based on the speech unit. By means of the method, a reply speech signal corresponding to reply text can be quickly and efficiently generated.

In some embodiments, the computing device 108 selects the text unit from the group of text units. Then, the computing device searches a speech library for the speech signal unit corresponding to the text unit based on the mapping relationship between a speech signal unit and a text unit. In this manner, the speech signal unit can be quickly obtained, thereby reducing the time for performing the process, and improving the efficiency.

In some embodiments, the speech library stores the mapping relationship between a speech signal unit and a text unit, the speech signal unit in the speech library is obtained by dividing acquired speech recording data related to the virtual object, and the text unit in the speech library is determined based on the speech signal unit obtained through division. The speech library is generated in the following manner. First, speech recording data related to a virtual object is acquired. For example, the voice of a real person corresponding to the virtual object is recorded. Then, the speech recording data. is divided into a plurality of speech signal units. After the speech signal units are obtained through division, a plurality of text units corresponding to the plurality of speech signal units are determined, wherein a first speech signal unit corresponds to one text unit. Then, a speech signal unit of the plurality of speech signal units and the corresponding text unit of the plurality of text units are stored in the speech library in association with each other, thereby generating the speech library. In this manner, the efficiency of acquiring a speech signal unit of text can be improved, and the acquisition time can be reduced.

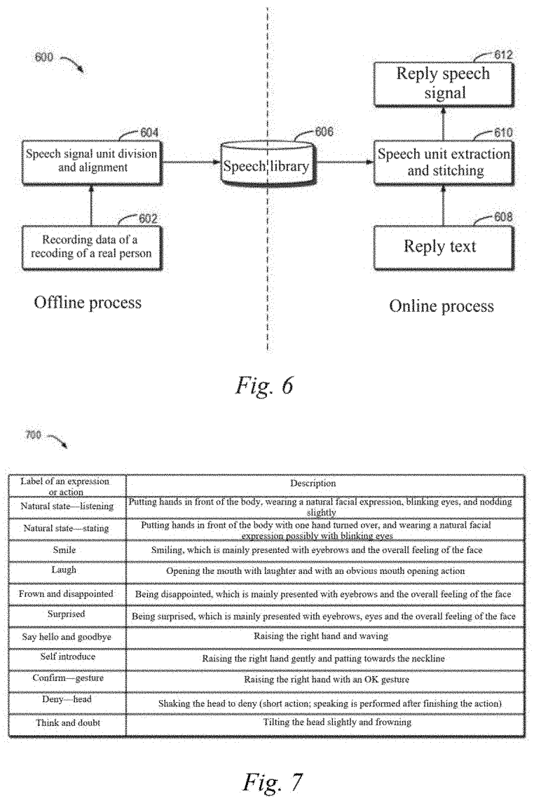

The following specifically describes a process of generating a reply speech signal in conjunction with FIG. 6. FIG. 6 shows a flowchart of a method 600 for generating a reply speech signal according to some embodiments of the present disclosure.

As shown in FIG. 6, in order to make a machine simulate real person chatting in a more realistic manner, the voice of a real person consistent with a virtual image is used to generate a reply speech signal. The process 600 includes two parts: an offline part and an online part. In the offline part, at block 602, recording data of a recording of the real person consistent with the virtual image is collected. Then, after block 604, a recorded speech signal is divided into speech units, and the speech units are aligned with corresponding text units to obtain a speech library 606, the speech library storing a speech signal corresponding to each word. The offline process can be performed on the computing device 108 or any other appropriate device.

In the online part, a corresponding speech signal is extracted from the speech library 606 according to a word sequence in reply text, to synthesize an output speech signal. First, at block 608, the computing device 108 obtains the reply text. Then, the computing device 108 divides the reply text 608 into a group of text units. Then, at block 610, speech units corresponding to the text units are extracted from the speech library 606 and stitched. Then, at block 612, the reply speech signal is generated. Therefore, the reply speech signal can be obtained online using the speech library.

Now referring back to FIG. 3 to continue description, at block 306, an identifier of an expression and/or action is determined based on the reply text, wherein the expression and/or action is presented by a virtual object. For example, the computing device 108 determines the identifier 210 of the expression and/or action based on the reply text 206, wherein the expression and/or action is presented by the virtual object 110.

In some embodiments, the computing device 108 inputs the reply text to an expression and action recognition model to obtain the identifier of the expression and/or action, the expression and action recognition model being a machine learning model which determines the identifier of the expression and/or action using text. By means of the method, an expression and/or action to be used can be quickly and accurately determined with text.

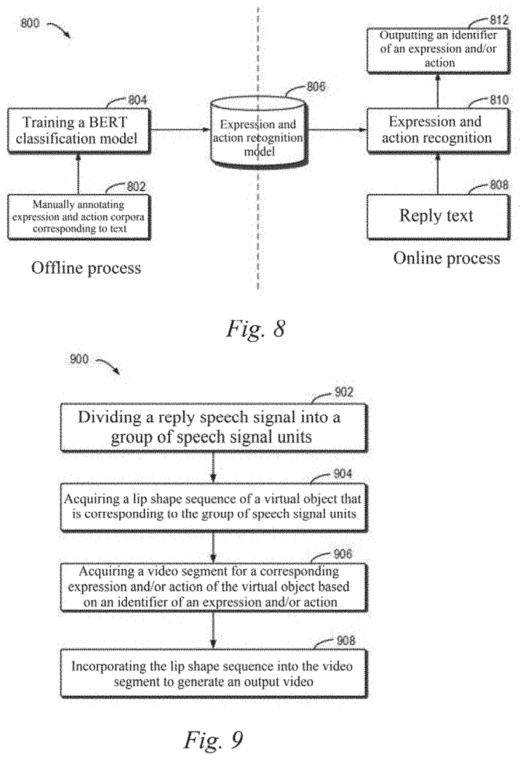

The following describes the identifier of the expression and/or action and description of the expression and action in conjunction with FIG. 7 and FIG. 8. FIG. 7 shows a schematic diagram of an example 700 of an expression and/or action according to some embodiments of the present disclosure; FIG. 8 shows a flowchart of a method 800 for acquiring and using an expression and action recognition model according to some embodiments of the present disclosure.

In the dialog, an expression and an action of the virtual object 110 are determined by dialog content. The virtual person can reply with a happy expression to “I'm happy”, and reply with an action of waving a hand to “Hello”. Therefore, expression and action recognition are to recognize labels of an expression and an action of the virtual person according to reply text in a dialog model. The process includes two parts: expression and action label system setting and recognition.

In FIG. 7, 11 labels are set for high-frequency expressions and/or actions involved in a dialog process. Since expressions and actions work together in some scenarios, whether a label indicates an expression or an action is not strictly distinguished in the system. In some embodiments, expressions and actions may be set separately, and then be allocated with different labels or identifiers. When a label or identifier of an expression and/or action is to be obtained by using reply text, the label or identifier can be obtained by a trained model, or a corresponding expression label and action label may be separately obtained by a trained model for an expression and a trained model for an action. The above-mentioned example is only used to describe the present disclosure and does not constitute a specific limitation on the present disclosure.

A recognition process of an expression label and an action label is divided into an offline process and an online process as shown in FIG. 8. In the offline process, at block 802, a library of manually annotated expression and action corpora for dialog text is obtained. At block 804, a BERT classification model is trained to obtain an expression and action recognition model 806. In the online process, at block 808, reply text is obtained, and then the reply text is input to the expression and action recognition model 806 to perform expression and action recognition at block 810. Then, at block 812, an identifier of an expression and/or action is output. In some embodiments, the expression and action recognition model may be any appropriate machine learning model, such as various appropriate neural network models.

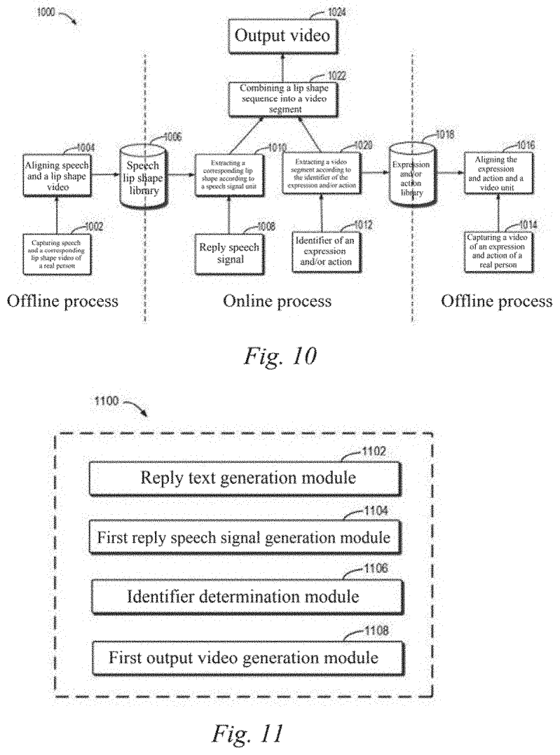

Now referring back to FIG. 3 to continue description, at block 308, an output video including the virtual object is generated based on the reply speech signal and the identifier of the expression and/or action, the output video including a lip shape sequence determined based on the reply speech signal and to be presented by the virtual object. For example, the computing device 108 generates the output video 212 including the virtual object 110 based on the reply speech signal 208 and the identifier 210 of the expression and/or action. The output video includes the lip shape sequence determined based on the reply speech signal and to be presented by the virtual object. The process is described in detail below in conjunction with FIG. 9 and FIG. 10.

In some embodiments, the computing device 108 outputs the reply speech signal 208 and the output video 212 in association with each other. By means of the method, correct and matched speech and video information can be generated. In this process, the reply speech signal 208 and the output video 212 are synchronized in terms of time to communicate with the user.

By means of the method, the range of interaction content can be significantly increased, the quality and level of human-machine interaction can be improved, and the user experience can be improved.

The flowchart of the method 300 for human-machine interaction according to some embodiments of the present disclosure is described above in conjunction with FIG. 3 to FIG. 8. The following specifically describes a process of generating an output video based on a reply speech signal and an identifier of an expression and/or action in conjunction with FIG. 9. FIG. 9 shows a flowchart of a method 900 for generating an output video according to some embodiments of the present disclosure.

At block 902, the computing device 108 divides the reply speech signal into a group of speech signal units. In some embodiments, the computing device 108 obtains the speech signal units through division in a unit of word. In some embodiments, the computing device 108 obtains the speech signal units through division in a unit of syllable. The above-mentioned example is only used to describe the present disclosure and does not constitute a specific limitation on the present disclosure. Those skilled in the art can obtain speech units through division with any appropriate speech size.

At block 904, the computing device 108 acquires a lip shape sequence of the virtual object corresponding to the group of speech signal units. The computing device 108 may search a corresponding database for a lip shape video corresponding to each speech signal. When a corresponding relationship between a speech signal unit and a lip shape is generated, a voice video of a real person corresponding to the virtual object is firstly recorded, and then the lip shape corresponding to the speech signal unit is extracted from the video. Then, the lip shape and the speech signal unit are stored in the database in association with each other.

At block 906, the computing device 108 acquires a video segment for the corresponding expression and/or action of the virtual object based on the identifier of the expression and/or action. The database or a storage apparatus pre-stores a mapping relationship between an identifier of the expression and/or action and a video segment of the corresponding expression and/or action. After the identifier such as a label or a type of the expression and/or action is obtained, the corresponding video can be found using the mapping relationship between an identifier and a video segment of the expression and/or action.

At block 908, the computing device 108 incorporates the lip shape sequence into the video segment to generate the output video. The computing device incorporates, into each frame of the video segment according to time, the obtained lip shape sequence corresponding to the group of speech signal units.

In some embodiments, the computing device 108 determines a video frame at a predetermined time position on a timeline in the video segment. Then, the computing device 108 acquires, from the lip shape sequence, a lip shape corresponding to the predetermined time position. After the lip shape is obtained, the computing device 108 incorporates the lip shape into the video frame, thereby generating the output video. In this mariner, a video including a correct lip shape can be quickly obtained.

By means of the method, a lip shape of a virtual person can be enabled to more accurately match a voice and an action, and the user experience is improved.

The flowchart of the method 900 for generating the output video according to some embodiments of the present disclosure is described above in conjunction with FIG. 9. The following further describes a process of generating an output video according to further description in conjunction with FIG. 10. FIG. 10 shows a flowchart of a method 1000 for generating an output video according to some embodiments of the present disclosure.

In FIG. 10, generating a video comprises synthesizing a video segment of a virtual person according to a reply speech signal and labels of an expression and an action. The process is shown in FIG. 10 and comprises three parts: lip shape video acquisition, expression and action video acquisition, and video rendering.

The lip shape video acquisition process is divided into an online process and an offline process. In the offline process, at block 1002, speech and a corresponding lip shape video of a real person are captured. Then, at block 1004, the speech and the lip shape video of the real person are aligned. In the process, a lip shape video corresponding to each speech unit is obtained. Then, the obtained speech unit and lip shape video are correspondingly stored in a speech lip shape library 1006. In the online process, at block 1008, the computing device 108 obtains a reply speech signal. Then, at block 1010, the computing device 108 divides the reply speech signal into speech signal units, and then extracts a corresponding lip shape from the lip shape database 1006 according to a speech signal unit.

The expression and action video acquisition process is also divided into an online process and an offline process. In the offline process, at block 1014, a video of an expression and action of a real person is captured. Then, at block 1016, the video is divided to obtain a video corresponding to an identifier of each expression and/or action, that is, the expression and/or action are/is aligned with a video unit. Then, a label of the expression and/or action and the video are correspondingly stored in an expression and/or action library 1018. In some embodiments, the expression and/or action library 1018 stores a mapping relationship between an identifier of an expression and/or action and a corresponding video. In some embodiments, in the expression and/or action library, an identifier of an expression and/or action is used to find a corresponding video through multi-level mapping. The above-mentioned example is only used to describe the present disclosure and does not constitute a specific limitation on the present disclosure.

In the online process, at block 1012, the computing device 108 acquires an identifier of an input expression and/or action. Then, at block 1020, a video segment is extracted according to the identifier of the expression and/or action.

Then, at block 1022, a lip shape sequence is combined into the video segment. In this process, videos corresponding to labels of an expression and an action are stitched based on video frames on a timeline. Each lip shape is rendered into a video frame at the same position on the timeline according to the lip shape sequence, and the combined video is finally output. Then, at block 1024, the output video is generated.

FIG. 11 shows a schematic block diagram of an apparatus 1100 for human-machine interaction according to an embodiment of the present disclosure. As shown in FIG. 11, the apparatus 1100 comprises a reply text generation module 1102 configured to generate reply text of a reply to a received speech signal based on the speech signal. The apparatus 1100 further comprises a first reply speech signal generation module 1104 configured to generate a reply speech signal corresponding to the reply text based on a mapping relationship between a speech signal unit and a text unit, the reply text including a group of text units, and the generated reply speech signal including a group of speech units corresponding to the group of text units. The apparatus 1100 further comprises an identifier determination module 1106 configured to determine an identifier of an expression and/or action based on the reply text, wherein the expression and/or action is presented by a virtual object. The apparatus 1100 further comprises a first output video generation module 1108 configured to generate an output video including the virtual object based on the reply speech signal and the identifier of the expression and/or action, the output video including a lip shape sequence determined based on the reply speech signal and to be presented by the virtual object.

In some embodiments, the reply text generation module 1102 comprises an input text generation module configured to recognize the received speech signal to generate input text; and a reply text acquisition module configured to acquire the reply text based on the input text.

In some embodiments, the reply text generation module comprises a model-based reply text acquisition module configured to input the input text and personality attributes of the virtual object to a dialog model to acquire the reply text, the dialog model being a machine learning model which generates the reply text using the personality attributes of the virtual object and the input text.

In some embodiments, the dialog model is obtained by performing training with personality attributes of the virtual object and dialog samples, the dialog samples including an input text sample and a reply text sample.

In some embodiments, the first reply speeth signal generation module comprises a text unit division module configured to divide the reply text into the group of text units; a speech signal unit acquisition module configured to acquire a speech signal unit corresponding to a text unit of the group of text units based on the mapping relationship between a speech signal unit and a text unit; and a second reply speech signal generation module configured to generate the reply speech signal based on the speech signal unit.

In some embodiments, the speech signal unit acquisition module includes a text unit selection module configured to select the text unit from the group of text units based on the mapping relationship between a speech signal unit and a text unit; and a searching module configured to search a speech library for the speech signal unit corresponding to the text unit.

In some embodiments, the speech library stores the mapping relationship between a speech signal unit and a text unit, the speech signal unit in the speech library is obtained by dividing acquired speech recording data related to the virtual object, and the text unit in the speech library is determined based on the speech signal unit obtained through division.

In some embodiments, the identifier determination module 1106 comprises an expression and action identifier acquisition module configured to input the reply text to an expression and action recognition model to obtain the identifier of the expression and/or action, the expression and action recognition model being a machine learning model which determines the identifier of the expression and/or action using text.

In some embodiments, the first output video generation module 1108 comprises a speech signal division module configured to divide the reply speech signal into a group of speech signal units; a lip shape sequence acquisition module configured to acquire a lip shape sequence of the virtual object corresponding to the group of speech signal units; a video segment acquisition module configured to acquire a video segment for the expression and/or action of the virtual object based on the identifier of the corresponding expression and/or action; and a second output video generation module configured to incorporate the lip shape sequence into the video segment to generate the output video.

In some embodiments, the second output video generation module includes a video frame determination module configured to determine a video frame at a predetermined time position on a timeline in the video segment; a lip shape acquisition module configured to acquire, from the lip shape sequence, a lip shape corresponding to the predetermined time position; and an incorporation module configured to incorporate the lip shape into the video frame to generate the output video.

In some embodiments, the apparatus 1100 further comprises an output module configured to output the reply speech signal and the output video in association with each other.

According to an embodiment of the present disclosure, the present disclosure further provides an electronic device, a readable storage medium, and a computer program product.

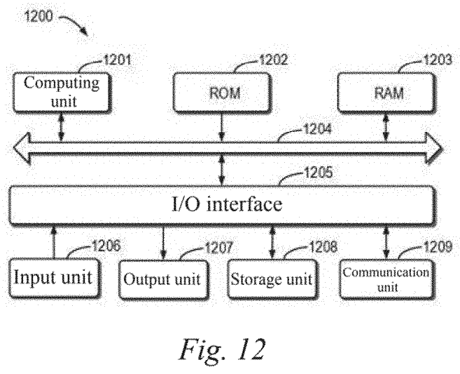

FIG. 12 shows a schematic block diagram of an example electronic device 1200 that can be used to implement the embodiments of the present disclosure. The terminal 104 and the computing device 108 in FIG. 1 can be implemented by the electronic device 1200. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 12, the device 1200 comprises a computing unit 1201, which may perform various appropriate actions and processing according to a computer program stored in a read-only memory (ROM) 1202 or a computer program loaded from a storage unit 1208 to a random access memory (RAM) 1203. The RAM 1203 may further store various programs and data required for the operation of the device 1200. The computing unit 1201, the ROM 1202, and the RAM 1203 are connected to each other through a bus 1204. An input/output (I/O) interface 1205 is also connected to the bus 1204.

A plurality of components in the device 1200 are connected to the I/O interface 1205, including: an input unit 1206, such as a keyboard or a mouse; an output unit 1207, such as various types of displays or speakers; the storage unit 1208, such as a magnetic disk or an optical disc; and a communication unit 1209, such as a network interface card, a modem, or a wireless communication transceiver. The communication unit 1209 allows the device 1200 to exchange information/data with other devices through a computer network such as the Internet and/or various telecommunications networks.

The computing unit 1201 may be various general-purpose and/or special-purpose processing components with processing and computing capabilities. Some examples of the computing unit 1201 include, but are not limited to, a central processing unit (CPU), a graphics processing unit (GPU), various dedicated artificial intelligence (Al) computing chips, various computing units that run machine learning model algorithms, a digital signal processor (DSP), and any appropriate processor, controller, microcontroller, etc. The computing unit 1201 performs the various methods and processing described above, such as the methods 200, 300, 400, 600, 800, 900, and 1000. For example, in some embodiments, the methods 200, 300, 400, 600, 800, 900, and 1000 may be implemented as a computer software program, which is tangibly contained in a machine-readable medium, such as the storage unit 1208. In some embodiments, a part or all of the computer program may be loaded and/or installed onto the device 1200 via the ROM 1202 and/or the communication unit 1209. When the computer program is loaded to the RAM 1203 and executed by the computing unit 1201, one or more steps of the methods 200, 300, 400, 600, 800, 900, and 1000 described above can be performed. Alternatively, in other embodiments, the computing unit 1201 may be configured, by any other suitable means (for example, by means of firmware), to perform the methods 200, 300, 400, 600, 800, 900, and 1000.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may comprise: the systems and technologies are implemented in one or more computer programs, wherein the one or more computer programs may be executed and/or interpreted on a programmable system comprising at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

A program code used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and pointing apparatus (for example, a mouse or a trackball) through which the user can provide an input to the computer. Other types of apparatuses can also be used to provide interaction with the user, for example, feedback provided to the user can be any form of sensory feedback (for example, visual feedback, auditory feedback, or tactile feedback), and an input from the user can be received in any form (including a voice input, speech input, or tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) comprising a frontend component, or a computing system comprising any combination of the backend component, the middleware component, or the frontend component. The components of the system can be connected to each other through digital data communication (for example, a communications network) in any form or medium. Examples of the communications network comprise: a local area network (LAN), a wide area network (WAN), and the Internet.

A computer system may comprise a client and a server. The client and the server are generally far away from each other and usually interact through a communications network. A relationship between the client and the server is generated by computer programs running on respective computers and having a client-server relationship with each other.

It should be understood that steps may be reordered, added, or deleted based on the various forms of procedures shown above. For example, the steps recited in the present disclosure can be performed in parallel, in order, or in a different order, provided that the desired result of the technical solutions disclosed in the present disclosure can be achieved, which is not limited herein.

The specific implementations above do not constitute a limitation on the protection scope of the present disclosure. Those skilled in the art should understand that various modifications, combinations, sub-combinations, and replacements can be made according to design requirements and other factors. Any modifications, equivalent replacements, improvements, etc. within the spirit and principle of the present disclosure shall fall within the protection scope of the present disclosure.

1. A method for human-machine interaction, comprising:
generating, using at least one processor, reply text of a reply to a received speech signal based on the speech signal;
generating, using at least one processor, a reply speech signal corresponding to the reply text based on a mapping relationship between a speech signal unit and a text unit, the reply text including a group of text units, and the generated reply speech signal including a group of speech signal units corresponding to the group of text units;
determining, using at least one processor, an identifier of at least one of an expression and action based on the reply text, wherein the at least one of the expression and action is presented by a virtual object; and
generating, using at least one processor, an output video including the virtual object based on the reply speech signal and the identifier of the at least one of the expression and action, the output video including a lip shape sequence determined based on the reply speech signal and to be presented by the virtual object.

2. The method according to claim 1, wherein generating the reply text comprises:
recognizing the received speech signal to generate input text; and
acquiring the reply text based on the input text.

3. The method according to claim 2, wherein acquiring the reply text based on the input text comprises:
inputting personality attributes of the virtual object and the input text to a dialog model to acquire the reply text, the dialog model being a machine learning model which generates the reply text using the personality attributes of the virtual object and the input text.

4. The method according to claim 3, wherein the dialog model is obtained by performing training with personality attributes of the virtual object and dialog samples, the dialog samples including an input text sample and a reply text sample.

5. The method according to claim 1, wherein generating the reply speech signal comprises:
dividing the reply text into the group of text units;
acquiring a speech signal unit corresponding to a text unit of the group of text units based on the mapping relationship between a speech signal unit and a text unit; and
generating the reply speech signal based on the speech signal unit.

6. The method according to claim 5, wherein acquiring the speech signal unit comprises:
selecting the text unit from the group of text units; and
searching a speech library for the speech signal unit corresponding to the text unit based on the mapping relationship between a speech signal unit and a text unit.

7. The method according to claim 6, wherein the speech library stores the mapping relationship between a speech signal unit and a text unit, the speech signal unit in the speech library being obtained by dividing acquired speech recording data related to the virtual object, the text unit in the speech library being determined based on the speech signal unit obtained through division.

8. The method according to claim 1, wherein determining the identifier of the at least one of the expression and action comprises:
inputting the reply text to an expression and action recognition model to obtain the identifier of the at least one of the expression and action, the expression and action recognition model being a machine learning model which determines the identifier of the at least one of the expression and action using text.

9. The method according to claim 1, wherein generating the output video comprises:
dividing the reply speech signal into a group of speech signal units;
acquiring a lip shape sequence of the virtual object corresponding to the group of speech signal units;
acquiring a video segment for the at least one of the expression and action of the virtual object based on the identifier of the at least one of the corresponding expression and action; and
incorporating the lip shape sequence into the video segment to generate the output video.

10. The method according to claim 9, wherein incorporating the lip shape sequence into the video segment to generate the output video comprises:
determining a video frame at a predetermined time position on a timeline in the video segment;
acquiring, from the lip shape sequence, a lip shape corresponding to the predetermined time position; and
incorporating the lip shape into the video frame to generate the output video.

11. The method according to claim 1, further comprising:
outputting, using at least one processor, the reply speech signal and the output video in association with each other.

12. An electronic device, comprising:
at least one processor; and
a memory communicatively connected to the at least one processor, wherein the memory stores instructions configured to be executed by the at least one processor, the instructions, when executed by the at least one processor, causing the at least one processor to perform acts, comprising:
generating reply text of a reply to a received speech signal based on the speech signal;
generating a reply speech signal corresponding to the reply text based on a mapping relationship between a speech signal unit and a text unit, the reply text including a group of text units, and the generated reply speech signal including a group of speech signal units corresponding to the group of text units;
determining an identifier of at least one of an expression and action based on the reply text, wherein the at least one of the expression and action is presented by a virtual object; and
generating an output video including the virtual object based on the reply speech signal and the identifier of the at least one of the expression and action, the output video including a lip shape sequence determined based on the reply speech signal and to be presented by the virtual object.

13. The electronic device according to claim 12, wherein generating reply text comprises:
recognizing the received speech signal to generate input text; and
acquiring the reply text based on the input text.

14. The electronic device according to claim 13, wherein acquiring the reply text based on the input text comprises:
inputting personality attributes of the virtual object and the input text to a dialog model to acquire the reply text, the dialog model being a machine learning model which generates the reply text using the personality attributes of the virtual object and the input text.

15. The electronic device according to claim 14. wherein the dialog model is obtained by performing training with personality attributes of the virtual object and dialog samples, the dialog samples including an input text sample and a reply text sample.

16. The electronic device according to claim 12, wherein generating the reply speech signal comprises:
dividing the reply text into the group of text units;
acquiring a speech signal unit corresponding to a text unit of the group of text units based on the mapping relationship between a speech signal unit and a text unit; and
generating the reply speech signal based on the speeth signal unit.

17. The electronic device according to claim 16, wherein acquiring the speech signal unit comprises:
selecting the text unit from the group of text units; and
searching a speech library for the speech signal unit corresponding to the text unit based on the mapping relationship between a speech signal unit and a text unit.

18. The electronic device according to claim 17, wherein the speech library stores the mapping relationship between a speech signal unit and a text unit, the speech signal unit in the speech library being obtained by dividing acquired speech recording data related to the virtual object, the text unit in the speeth library being determined based on the speech signal unit obtained through division.

19. The apparatus according to claim 12, wherein determining the identifier of the at least one of the expression and action comprises:
inputting the reply text to an expression and action recognition model to obtain the identifier of the at least one of the expression and action, the expression and action recognition model being a machine learning model which determines the identifier of the at least one of the expression and action.

20. A non-transitory computer-readable storage medium storing computer instructions that, when executed by at least one processor of a computer, cause the computer to perform acts, comprising:
generating reply text of a reply to a received speech signal based on the speech signal;
generating a reply speech signal corresponding to the reply text based on a mapping relationship between a speech signal unit and a text unit, the reply text including a group of text units, and the generated reply speech signal including a group of speech signal units corresponding to the group of text units;
determining an identifier of at least one of an expression and action based on the reply text, wherein the at least one of the expression and action is presented by a virtual object; and
generating an output video including the virtual object based on the reply speech signal and the identifier of the at least one of the expression and action, the output video including a lip shape sequence determined based on the reply speech signal and to be presented by the virtual object.
